(19) United States
(12) Patent Application Publication
(10) Pub. No.: US 2025/0117002 A1
(43) Pub. Date: Apr. 10, 2025

(54) PRECISION TIMING OF PROCESSING ACTIONS IN MANUFACTURING SYSTEMS

(71) Applicant: Applied Materials, Inc., Santa Clara, CA (US)

(72) Inventors: Geethanzali Kamalanathan, Milpitas, CA (US); Vivek Bharat Shah, Santa Clara, CA (US); John Poulose, San Jose, CA (US); Ghadeh Hadi, Santa Clara, CA (US)

(21) Appl. No.: 18/481,171

(22) Filed: Oct. 4, 2023

(51) Int. Cl. G05B 19/418

(52) U.S. Cl. CPC G05B 19/41885; G05B 19/41865; G05B 2219/45031

(57) ABSTRACT

A method includes identifying a target substrate process operation start time. The start time corresponds to a time of initiation of one or more substrate process actions. The method further includes providing to a model first one or more parameters of a gas transfer system associated with the substrate process operation. The method further includes obtaining first output from the model. The first output includes an indication of a first preemptive time period for initiation of first one or more gas delivery actions. The method further includes updating a process recipe. The process recipe is updated in accordance with the first preemptive time period. Updating the process recipe is to cause the first one or more gas delivery actions to deliver a first process gas to a process chamber within a threshold time window of the substrate process operation start time.

### TECHNICAL FIELD

The present disclosure relates to methods associated with timing of actions related to processing in manufacturing systems. More specifically, the present disclosure relates to methods associated with precision timing of actions related to processing actions in manufacturing systems.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Product properties are influenced by processing conditions that the substrate is subjected to during processing and/or manufacturing operations. Throughout processing, one or more operations may be performed on a substrate with start and end times of the operations. Control of a timing of conditions proximate a substrate during processing may have an influence on properties of the manufactured substrate.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes identifying a target substrate process operation start time. The start time corresponds to a time of initiation of one or more substrate process actions. The method further includes providing to a model first one or more parameters of a gas transfer system associated with the substrate process operation. The method further includes obtaining first output from the model. The first output includes an indication of a first preemptive time period for initiation of first one or more gas delivery actions. The method further includes updating a process recipe. The process recipe is updated in accordance with the first preemptive time period. Updating the process recipe is to cause the first one or more gas delivery actions to deliver a first process gas to a process chamber within a threshold time window of the substrate process operation start time.

In another aspect of the present disclosure, a method includes obtaining a first plurality of gas transfer parameter data. The method further includes obtaining a first plurality of time delay data. The first plurality of time delay data corresponds to the first plurality of gas transfer parameter data. Each of the first plurality of time delay data corresponds to a duration of time between performance of one or more gas transfer operations and accumulation of a threshold concentration of one or more process gases in a substrate processing chamber. The method further includes providing the first plurality of gas transfer parameter data to a machine learning model as training input. The method further includes providing the first plurality of time delay data to the machine learning model as target output. The method further includes training the machine learning model to generate a trained machine learning model. The trained machine learning model is configured to receive as input gas transfer parameters and generate as output time delay data.

In another aspect of the present disclosure, a non-transitory machine-readable storage medium stores instructions which, when executed, cause a processing device to perform operations. The operations include identifying a target substrate process operations start time. The start time corresponds to a time of initiation of one or more substrate process actions. The operations further include providing to a model first one or more parameter of a gas transfer system associated with the substrate process operation. The operations further include obtaining first output from the model. The first output includes an indication of a first preemptive time period for initiation of one or more gas delivery actions. The operations further include initiating the one or more gas delivery actions in accordance with the first preemptive time period. Initiating the one or more gas delivery actions is to deliver a first process gas to a process chamber within a threshold time window of the substrate process operation start time.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts a block diagram of a system including an example data set generator for creating data sets for one or more supervised models, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for performing a corrective action based on a substrate processing delay time, according to some embodiments.

FIG. 4C is a flow diagram of a method for generating a trained machine learning model for predictive time delay data, according to some embodiments.

FIG. 4D is a flow diagram of a method for causing delivery of a process gas to a process chamber within a target time window, according to some embodiments.

FIG. 5A is a block diagram of a gas transfer system, according to some embodiments.

FIG. 5B is a time trace plot of condition values in a process chamber, according to some embodiments.

FIG. 6 is a block diagram illustrating a computer system, according to some embodiments.

### DETAILED DESCRIPTION

Described herein are technologies related to gas handling in manufacturing processes. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. Manufacturing systems may introduce various materials such as process gases, flushing gases, etc., at various times in a process operation. Materials introduced may interact with the substrate to produce some target effect. Materials may be intended to interact with the substrate from some target process operation start time until some target process operation end time, potentially corresponding to one or more other process parameters. Correspondence to another process parameter may include correspondence to a time the substrate is at a target temperature, a time the substrate is exposed to a second material, a time that radio frequency (RF) power is applied to produce plasma, or the like. In some embodiments, trained machine learning models are utilized to improve performance of manufacturing equipment.

A recipe for a process procedure (e.g., a substrate processing procedure) includes instructions for performing one or more operations. The recipe including indications causing various components of the manufacturing system to perform actions associated with processing. The recipe includes indications of times to perform these actions, times for parameters to be at target set points within the process chamber, etc.

In some systems, two or more process actions are to be performed synchronously. For example, gas may be intended to be provided when a target substrate temperature is achieved. As another example, a first gas and a second gas may be intended to be provided to the substrate at the same time. As another example, a gas may be provided when a target RF power is achieved.

In some systems, actions to achieve synchronous activity may be performed in accordance with a target substrate operation start time. Actions may be initiated at a time corresponding to the substrate operation start time. The operation may include an etch or deposition step, a gas processing step, etc. In some systems, conditions experienced by the substrate may lag behind start times of various operations. For example, power applied to a heater may not cause in increase to the temperature of the substrate for a delay, opening of a gas valve cause delivery of a gas to the substrate delayed by some travel time, etc.

In some systems, delay times of various components or processes may vary. For example, temperature change delays may be different than gas delivery delays, delivery of a first gas or gas mix may be delayed by a different amount than a second gas or gas mix, etc. As a result of effects on a substrate being associated with different delay times for different actions, conditions at the substrate meant to be synchronous may occur at different times, may be initiated at different times, or the like.

Various aspects of substrate processing operations may be impacted by unknown or inconsistent condition initiation times for substrate processing operations. Various aspects of substrate processing may be impacted by unknown or inconsistent gas delivery times to a substrate.

As a first example of an impact of delay of adjustment to processing conditions compared to initiation of processing actions, gas delivery may be delayed compared to initiation of gas delivery actions. Upon initiation of gas delivery actions, a valve may be actuated or another method of delivering gas may be performed. The gas may travel toward a target delivery zone (e.g., one of one or more delivery areas in the process chamber). The gas may be provided to a substrate processing area, to a surface of the substrate, or the like some time after initiation of gas delivery actions. Gas may be provided to a substrate for a target amount of time, e.g., to accomplish a target degree of deposition, etching, or other chemistry. In a recipe design phase, a duration of a gas process may have been determined based on a target exposure time of the substrate to a gas. The duration of the operation may include processing time and additional time relating to a delay between gas delivery actions and gas delivery to the substrate. Such recipes include some amount of time that is not contributing to substrate processing. In some recipes, such as cyclic recipes including many cycles of introducing one or more gases, such “dead time” may accumulate to be a significant investment.

As a second example of an impact of delay, gas delivery may be desynched from other process actions or conditions. For example, delivery of two gases may be intended to by synchronous, but due to differences in gas delivery architecture or arrangements, delivery of the two gases may occur at different times. Processes may be less effective, less reliable, less predictable, or the like based on different delays of various process actions.

Problems of delay mismatch may be compounded by differences between various process chambers, process tools, process tool components, process tool gas delivery systems, or the like. Attempts to account for delay may not be applicable upon a change in process conditions, a change in equipment components, a change in a source location of a gas, a change in gas delivery, a change to a different tool or chamber, etc.

Methods and systems of the present disclosure may address one or more shortcomings of conventional solutions. In some embodiments of the present disclosure, corrections for delayed actions may be implemented. Corrections may be implemented for delays of gas transfer, including delivery of gases to a substrate processing region, removal or process gases from the substrate processing region, etc.

In some embodiments, a model may be generated that provides predictions of delay between initiating actions and changes to property values at the location of the substrate. The model may be a physics-based model. The physics-based model may be based on a fluid flow model, fluid dynamics model, gas conductance model, etc. The model may be a heuristic or empirical model. The model may be a trained machine learning model. The model may receive as input indications of parameters of a substrate processing action, and provide a prediction of a delay time between initiating the substrate processing action and the action having an effect on the substrate being processed.

One or more process parameters may be provided to the model, and one or more predicted delay times may be output by the model. Substrate processing operations may be adjusted based on the predicted delay times. One or more process recipes may be adjusted. One or more equipment constants may be adjusted.

For training/developing the model, measurements may be made of a time delay between initiating one or more process actions and changes to conditions experienced by the substrate. In some embodiments, conditions experienced by the substrate may be measured by measuring electromagnetic radiation from gases in a process chamber. In some embodiments, optical emission of a plasma may be utilized in determining when a process gas reaches the chamber, reaches the substrate processing area, reaches a target concentration, etc.

One or more time delays may be provided by the model. For example, a delay between initiation of gas delivery actions and delivery of the gas, and a delay between initiation of gas flushing actions and removal of the gas, may both be generated by the model. Delays related to multiple actions, which may be related to the same or different process parameters, may be generated. Delays related to multiple different process gases may be generated. Parameters provided to the model may include target gas delivery zones, including chamber and region of the chamber, a source location of process and/or carrier gases, identity of process and/or carrier gases, pressures of process and/or carrier gases, etc.

Methods and systems of the current disclosure enable technical advantages over previous solutions. By providing process action parameters to a model, receiving output of the model, and performing corrective actions based on the output, a manufacturing system may have the advantage of decreasing useless or dead time in a process procedure. The manufacturing system may increase a proportion of time, of the time that the substrate is in the manufacturing system, that the substrate is being actively processed. The manufacturing system may reduce an amount of time for processing a substrate. The manufacturing system may increase throughput of the system, which may increase a rate at which substrates are manufactured, decrease energy and/or material costs per substrate, decrease environmental impact per substrate, etc.

Standards for manufacturing of substrates have become ever more stringent. As devices become more compact, more precision is expected of processed substrates. Methods and systems of the current disclosure may increase a reliability of substrate processing operations by more closely matching an actual start time for a process (e.g., when conditions are met at the location of a substrate) with an assumed process start time (e.g., the recipe operations nominal start time). For example, intended chemistry may be present at the substrate when the substrate reaches a target temperature or is exposed to a target exposure of plasma. Providing intended process conditions may improve a reliability of a process operation, reduce defective products produced, etc. Increasing a reliability of the process operation may decrease a cost associated with generating defective products, such as disposal, energy and time consumed, materials consumed, etc. Increasing a reliability of the process operation may increase useful products generated, which may reduce an environmental impact of the process, reduce wear and tear on equipment per substrate produced, reduce frequency and/or intensity of planned maintenance, reduce frequency of unplanned maintenance, etc.

Maintaining consistency between process chambers, process tools, process facilities, etc., may be challenging. Providing one or more process operation parameters to a model, receiving output from the model, and making a corrective action in view of a time delay of the model output may improve a consistency between various manufacturing equipment, chambers, or the like. Timing of process actions having effects on substrates may be standardized across chambers, tools, facilities, etc., causing various manufacturing systems to behave more uniformly. Uniform performance may increase a proportion of successfully produced products, decrease costs associated with producing faulty products, reduce energy expenditure, material expenditure, and environmental impact of processing operations per successful substrate produced, etc.

In some aspects of the current disclosure, a method includes identifying a target substrate process operation start time. The start time corresponds to a time of initiation of one or more substrate process actions. The method further includes providing to a model first one or more parameters of a gas transfer system associated with the substrate process operation. The method further includes obtaining first output from the model. The first output includes an indication of a first preemptive time period for initiation of first one or more gas delivery actions. The method further includes updating a process recipe. The process recipe is updated in accordance with the first preemptive time period. Updating the process recipe is to cause the first one or more gas delivery actions to deliver a first process gas to a process chamber within a threshold time window of the substrate process operation start time.

In another aspect of the present disclosure, a method includes obtaining a first plurality of gas transfer parameter data. The method further includes obtaining a first plurality of time delay data. The first plurality of time delay data corresponds to the first plurality of gas transfer parameter data. Each of the first plurality of time delay data corresponds to a duration of time between performance of one or more gas transfer operations and accumulation of a threshold concentration of one or more process gases in a substrate processing chamber. The method further includes providing the first plurality of gas transfer parameter data to a machine learning model as training input. The method further includes providing the first plurality of time delay data to the machine learning model as target output. The method further includes training the machine learning model to generate a trained machine learning model. The trained machine learning model is configured to receive as input gas transfer parameters and generate as output time delay data.

In another aspect of the present disclosure, a non-transitory machine-readable storage medium stores instructions which, when executed, cause a processing device to perform operations. The operations include identifying a target substrate process operations start time. The start time corresponds to a time of initiation of one or more substrate process actions. The operations further include providing to a model first one or more parameter of a gas transfer system associated with the substrate process operation. The operations further include obtaining first output from the model. The first output includes an indication of a first preemptive time period for initiation of one or more gas delivery actions. The operations further include initiating the one or more gas delivery actions in accordance with the first preemptive time period. Initiating the one or more gas delivery actions is to deliver a first process gas to a process chamber within a threshold time window of the substrate process operation start time.

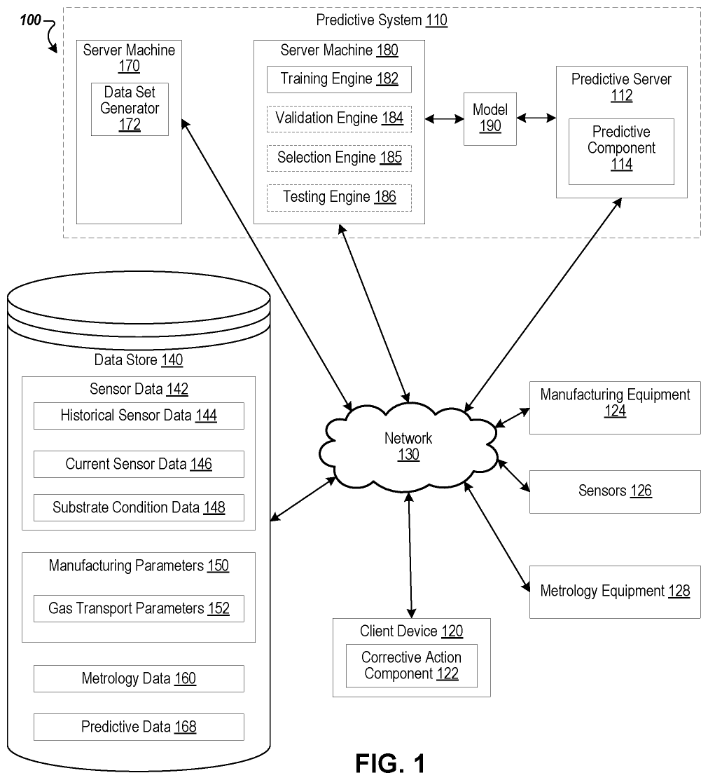

FIG. 1 is a block diagram illustrating an exemplary system 100 (exemplary system architecture), according to some embodiments. The system 100 includes a client device 120, manufacturing equipment 124, sensors 126, metrology equipment 128, predictive server 112, and data store 140. The predictive server 112 may be part of predictive system 110. Predictive system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Sensors 126 and sensor data 142 may include components and data directed toward determining when one or more process actions take effect, e.g., optical sensors used to determine when a process gas reaches a substrate. Electromagnetic radiation sensors may be used to determine values of one or more conditions proximate a substrate processing region.

Electromagnetic sensors may be used to determine concentration of one or more gases. Sensor data 142 may include determining the presence of a process gas in a process chamber. Sensor data 142 may include data indicating a concentration of process gas in a process chamber. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may include historical sensor data 144, current sensor data 146, and substrate condition data 148. Current sensor data 146 may be associated with a product currently being processed, a product recently processed, a number of recently processed products, etc. Historical sensor data 144 may include data stored associated with previously produced products. Historical sensor data 144 may be used to train a machine learning model, e.g., model 190. Substrate condition data 148 may include indications of conditions at the location of a substrate. Substrate condition data 148 may include timing data, e.g., a timing delay between initiating actions to change conditions at the substrate and changes to conditions proximate the substrate actually occurring. Substrate condition data 148 may be utilized in developing and/or training a model. Historical sensor data 144 and/or current sensor data 146 may include attribute data, e.g., labels of manufacturing equipment ID or design, sensor ID, type, and/or location, label of a state of manufacturing equipment, such as a present fault, service lifetime, etc.

Sensor data 142 may be associated with or indicative of manufacturing parameters such as hardware parameters (e.g., hardware settings or installed components, e.g., size, type, etc.) of manufacturing equipment 124 or process parameters (e.g., heater settings, gas flow, etc.) of manufacturing equipment 124. Data associated with some hardware parameters and/or process parameters may, instead or additionally, be stored as manufacturing parameters 150, which may include historical manufacturing parameters (e.g., associated with historical processing runs) and current manufacturing parameters. Manufacturing parameters 150 may be indicative of input settings to the manufacturing device (e.g., heater power, gas flow, etc.). Sensor data 142 and/or manufacturing parameters 150 may be provided while the manufacturing equipment 124 is performing manufacturing processes (e.g., equipment readings while processing products). Sensor data 142 may be different for each product (e.g., each substrate). Substrates may have property values (film thickness, film strain, etc.) measured by metrology equipment 128, e.g., measured at a standalone metrology facility. Metrology data 160 may be a component of data store 140. Metrology data 160 may include historical metrology data 164 (e.g., metrology data associated with previously processed products). Metrology data 160 may be utilized in determining whether a process operation meets threshold performance conditions.

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data (e.g., metrology data associated with a product currently or recently processed).

In some embodiments, sensor data 142, metrology data 160, or manufacturing parameters 150 may be processed (e.g., by the client device 120 and/or by the predictive server 112). Processing of the sensor data 142 may include generating features. In some embodiments, the features are a pattern in the sensor data 142, metrology data 160, and/or manufacturing parameters 150 (e.g., slope, width, height, peak, etc.) or a combination of values from the sensor data 142, metrology data, and/or manufacturing parameters (e.g., power derived from voltage and current, etc.). Sensor data 142 may include features and the features may be used by predictive component 114 for performing signal processing and/or for obtaining predictive data 168. Predictive data 168 may include indications of adjustments to a process recipe. Predictive data 168 may include indications that may influence recipe design. Predictive data 168 may include indications that may be used to adjust a substrate processing procedure in progress, e.g., feed-forward control to future substrate processing operations based on predictive data associated with previously performed operations.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, predictive system 110 may generate predictive data 168 using supervised machine learning (e.g., predictive data 168 includes output from a machine learning model that was trained using labeled data, such as sensor data labeled with metrology data (e.g., which may include delay times for use in initiating substrate processing actions, etc.). In some embodiments, predictive system 110 may generate predictive data 168 using unsupervised machine learning (e.g., predictive data 168 includes output from a machine learning model that was trained using unlabeled data, output may include clustering results, principle component analysis, anomaly detection, etc.). In some embodiments, predictive system 110 may generate predictive data 168 using semi-supervised learning (e.g., training data may include a mix of labeled and unlabeled data, etc.).

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual and/or cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110. Corrective action component 122 may receive output (e.g., predictive data 168) from the predictive system 110. Corrective action component 122 may determine a corrective action based on the output. Corrective action component 122 may cause the corrective action to be implemented. In some embodiments, corrective action component 122 obtains sensor data 142 (e.g., current sensor data 146) associated with manufacturing equipment 124 (e.g., from data store 140, etc.) and provides sensor data 142 (e.g., current sensor data 146) associated with the manufacturing equipment 124 to predictive system 110.

In some embodiments, corrective action component 122 stores data to be used as input to a machine learning or other model (e.g., current sensor data 146 to be provided to model 190, etc.) in data store 140. A component of predictive system 110 (e.g., predictive server 112, server machine 170) may retrieve sensor data 142 from data store 140. In some embodiments, predictive server 112 may store output (e.g., predictive data 168) of the trained model(s) 190 in data store 140 and client device 120 may retrieve the output from data store 140.

In some embodiments, corrective action component 122 receives an indication of a corrective action from the predictive system 110 and causes the corrective action to be implemented. The corrective action may include adjusting a process recipe. The corrective action may include adjusting a substrate processing procedure in progress, e.g., updating future operations associated with a substrate based on previous operations associated with the substrate. Each client device 120 may include an operating system that allows users to one or more of generate, view, or edit data (e.g., indication associated with manufacturing equipment 124, corrective actions associated with manufacturing equipment 124, etc.).

In some embodiments, metrology data 160 corresponds to historical property data of products and predictive data 168 is associated with predicted property data (e.g., of products to be produced or that have been produced in conditions recorded by current sensor data 146 and/or current manufacturing parameters). Metrology data 160 may be used in determining and/or evaluating manufacturing equipment performance, recipe performance, gas transport system performance, etc.

In some embodiments, predictive data 168 is or includes an indication of any abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of progress of a processing operation being performed, e.g., to be used for process control. For example, gas delivery actions may be monitored, and sudden or gradual changes in monitored parameters of gas delivery actions may indicate damage or wear to one or more components of the manufacturing system.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product) into predictive system 110, receiving output of predictive data 168, and performing a corrective action based on the predictive data 168, system 100 can have the technical advantage of avoiding the cost of producing, identifying, and discarding defective products. By performing corrective actions based on predictive data 168, system 100 may increase a precision or reliability of timings associated with providing target processing conditions to a substrate. By performing corrective actions based on predictive data 168, system 100 may be provided with finer control of a timing of active chemistry, timing of process gas delivery, etc.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting sensor data 142 (e.g., indicative of a timing of introduction of target conditions as the location of a substrate) into a model, and performing one or more corrective actions based on output of the model, system 100 may have the technical advantage of providing process conditions to a substrate at a target time and for a target duration, which may increase reliability of system 100 and/or performance of produced substrates.

Performing manufacturing processes that result in failure of the components of the manufacturing equipment 124 can be costly in downtime, damage to products, damage to equipment, express ordering replacement components, etc. By monitoring processing procedures, determining time durations associated with achieving target conditions at target times, and monitoring changes to the time durations over time, system 100 may generate predictive data indicative of changes to the processing system, which may indicate useful corrective actions in association with the manufacturing equipment. By inputting sensor data 142 (e.g., indicative of manufacturing parameters that are being used or are to be used to manufacture a product), metrology data, measurement data, etc., receiving output of predictive data 168, and performing corrective action (e.g., predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert to a user (e.g., an alert indicating that timing parameters are different than expected). In some embodiments, performance of the corrective action includes causing updates to one or more manufacturing parameters. In some embodiments performance of a corrective action may include retraining a machine learning model associated with manufacturing equipment 124. In some embodiments, performance of a corrective action may include training a new machine learning model associated with manufacturing equipment 124.

Manufacturing parameters 150 may include hardware parameters. Hardware parameters may include information indicative of which components are installed in manufacturing equipment 124, indicative of component replacements, indicative of component age, indicative of software version or updates, etc. Manufacturing parameters 150 may include process parameters. Process parameters may include temperature, pressure, flow, rate, electrical current, voltage, gas flow, lift speed, etc. In some embodiments, the corrective action includes a updating a recipe. Updating a recipe may include adjusting initiation times of one or more processing actions, adjusting action timing compared to nominal operation start and/or end times, altering the timing of manufacturing subsystems entering an idle or active mode, altering set points of various property values, etc.

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, predictive component 114 may receive one or more indications of a substrate processing procedure and generate output related to predicted improvements to the procedure. Predictive component 114 may receive manufacturing parameters 150. Manufacturing parameters 150 may include one or more parameters that affect operations directed toward changing conditions at the location of a substrate being processed by manufacturing equipment 124. Manufacturing parameters 150 may include parameters related to a gas transport system. Manufacturing parameters 150 may include parameters of a gas providing system, e.g., a system for providing one or more gases to a substrate for operations associated with substrate processing. Manufacturing parameters 150 may include parameters of a gas removal system, e.g., a system for removing or replacing gases from the location of a substrate. Gas transport system parameters may be stores as part of manufacturing parameters 150 as gas transport parameters 152. Gas transport system parameters may include gas identity, gas mix (e.g., a mix of process gases, process gas and carrier gas, etc.), gas reservoir pressure, gas source location (e.g., from a plurality of sources or ports of the gas transport system), gas providing/removal pathway, gas delivery zone, or other parameters related to the gas transport system. Manufacturing parameters 150 provided to predictive component 114 may include other aspect of a gas transport system, such as identifiers of installed components, identifiers of specific properties of one or more components (e.g., due to aging or differences within manufacturing tolerance between nominally identical components), etc. Manufacturing parameters 150 provided to predictive component 114 may include other parameters that may not be directly associated with a system or subsystem of interest, but may have an indirect effect. For example, for modeling gas transport properties, manufacturing parameters related to substrate temperature may have an indirect effect on gas transport, and may be provided to predictive component 114.

Predictive component 114 may receive input data and generate output (e.g., predictive data 168) for performing corrective actions associated with the manufacturing equipment 124 based on the input data. Corrective actions may include performing recipe design, adjusting one or more process recipes, adjusting one or more process operations of a processing procedure in progress, etc. Predictive component 114 may, for example, receive data from client device 120 or retrieve data from data store 140. In some embodiments, predictive data 168 includes recommended corrective actions. Predictive data 168 may include recommended recipe and/or equipment constant updates. Predictive data 168 may include recommended timing updates associated with substrate processing actions. Predictive data 168 may include timing updates to more closely synchronize multiple effects of manufacturing equipment 124 in time. Predictive data 168 may include timing updates to more closely align changes to conditions proximate a substrate in time. In some embodiments, predictive data 168 may include one or more predicted dimension measurements of a processed product. In some embodiments, predictive component 114 may use one or more trained machine learning models 190 to determine the output for performing the corrective action based on input data.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., sensor data 142 (e.g., collected by sensors 126), manufacturing parameters 150 (e.g., associated with process control of manufacturing equipment 124), metrology data 160 (e.g., generated by metrology equipment 128), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives data as input to model 190, performs signal processing to break down the data into sets of data, provides the sets of data as input to a trained model 190, and obtains outputs indicative of predictive data 168 from the trained model 190. In some embodiments, predictive component 114 receives manufacturing parameters 150 as input data to be provided to model 190. In some embodiments, predictive component 114 receives manufacturing parameters 150 associated with a target sub-system of manufacturing equipment 124. Model 190 may be configured to receive the input data and generate predictive output, e.g., recommended corrective actions.

In some embodiments, the various models discussed in connection with model 190 (e.g., supervised machine learning model, unsupervised machine learning model, etc.) may be combined in one model (e.g., an ensemble model), or may be separate models.

Data may be passed back and forth between several distinct models included in model 190, corrective action component 122, and predictive component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, synthetic data 162, and predictive data 168.

Sensor data 142 may include historical sensor data 144, current sensor data 146, and substrate condition data 148. Substrate condition data 148 may be data associated with measuring conditions proximate the location of a substrate in a substrate processing chamber. For example, substrate condition data 148 may include data from sensors configured to determine a delay between initiation of a substrate processing action and an effect caused by initiation of the action at the location of the substrate. Substrate condition data 148 may include data from sensors configured to measure concentration of one or more process gases at or near a processing location of a process chamber. Substrate condition data 148 may include optical or other electromagnetic emission data from a target region. Substrate condition data 148 may be utilized in training a model, calibrating a model, generating a model, testing a model, determining whether performance of a chamber has changed or drifted, determining whether to update a model, etc.

Sensor data 142 may include sensor data time traces over the duration of manufacturing processes, associations of data with physical sensors, pre-processed data, such as averages and composite data, and data indicative of sensor performance over time (i.e., many manufacturing processes). Manufacturing parameters 150 and metrology data 160 may contain similar features, e.g., historical metrology data and current metrology data. Historical sensor data, historical metrology data, and historical manufacturing parameters may be historical data (e.g., at least a portion of these data may be used for training model 190). Current sensor data 146, current metrology data, and current manufacturing parameters may be current data (e.g., at least a portion to be input into learning model 190, subsequent to the historical data) for which predictive data 168 is to be generated. Predictive data 168 may be used for performing corrective actions such as recipe updating, recipe design, process operations adjustment, etc.

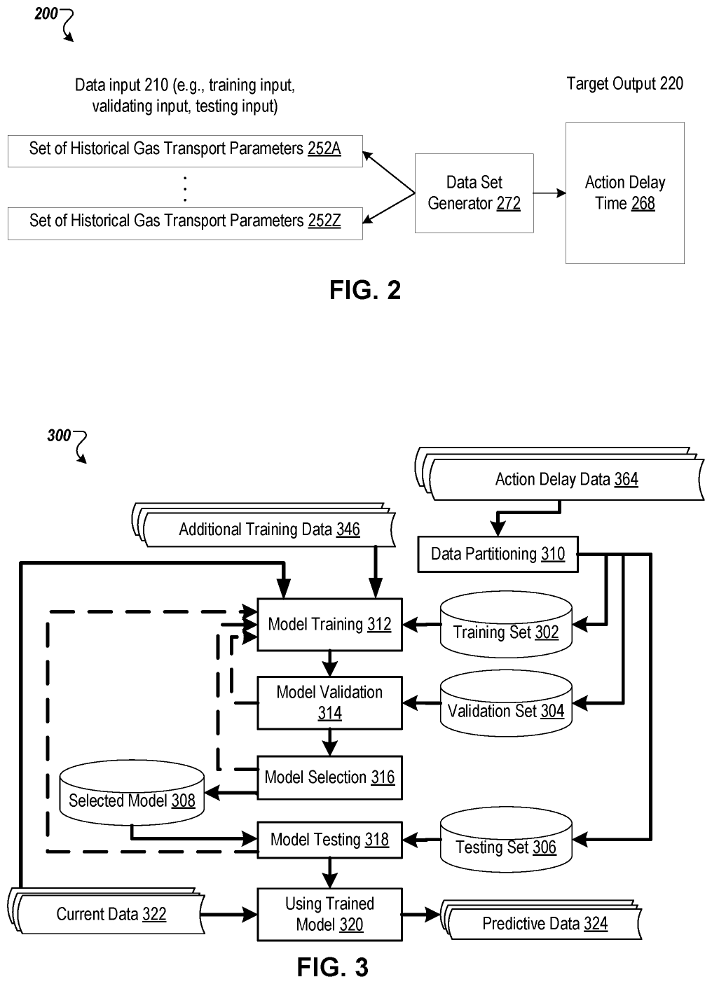

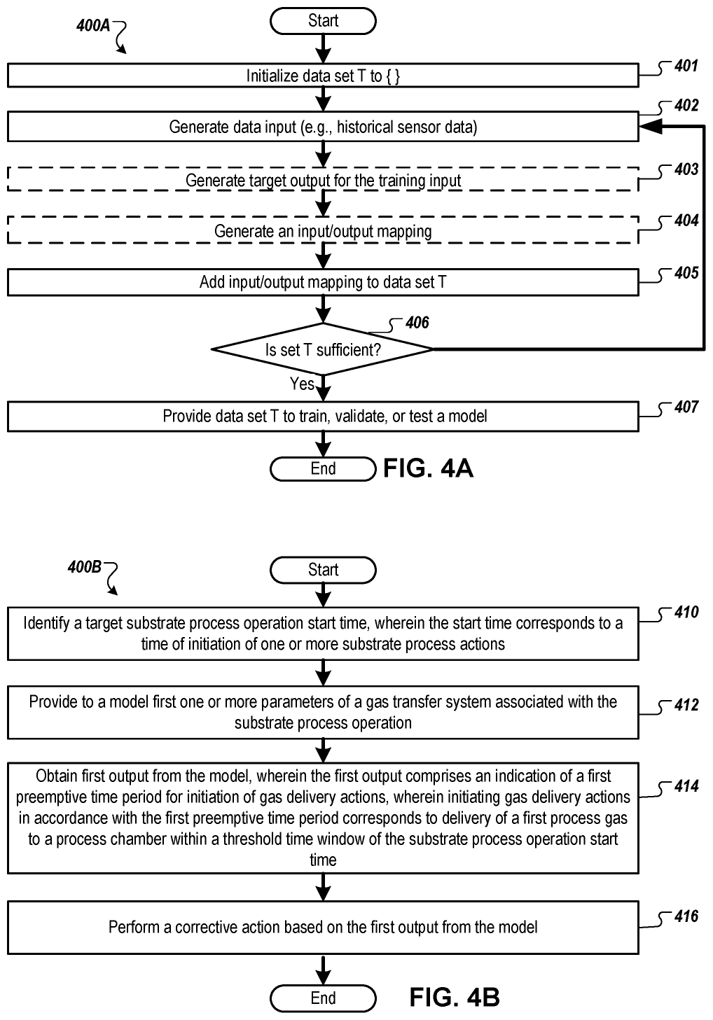

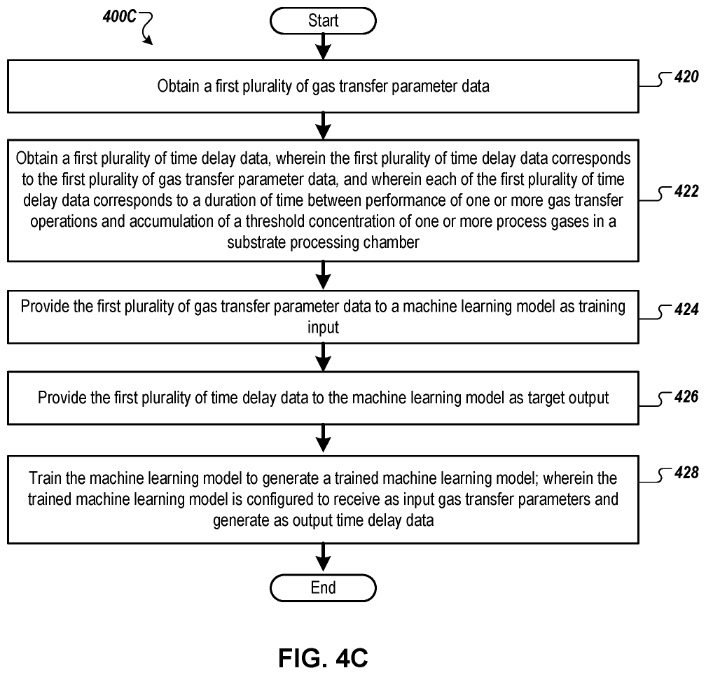

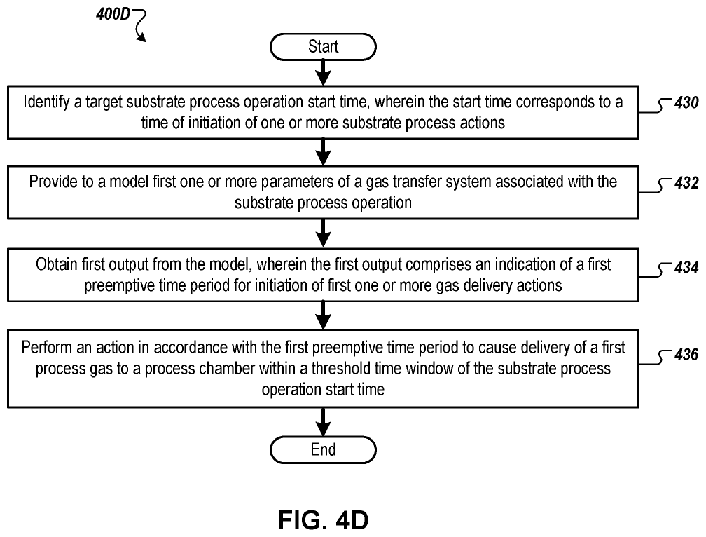

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2 and 4A. In some embodiments, data set generator 172 may partition the historical data (e.g., historical sensor data 144, historical manufacturing parameters, historical metrology data, historical portions of substrate condition data 148, historical portions of gas transport parameters 152, etc.) into a training set (e.g., sixty percent of the historical data), a validating set (e.g., twenty percent of the historical data), and a testing set (e.g., twenty percent of the historical data).

In some embodiments, predictive system 110 (e.g., via predictive component 114) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

In some embodiments, machine learning model 190 is provided historical data as training data. Machine learning model 190 may be provided substrate condition data 148 and/or gas transport parameters 152 as training data. The type of data provided will vary depending on the intended use of the machine learning model. For example, a machine learning model may be trained by providing the model with historical sensor data 144 as training input and corresponding metrology data 160 as target output. In some embodiments, a large volume of data is used to train model 190, e.g., sensor and metrology data of hundreds of substrates may be used. In some embodiments, a fairly small volume of data is available to train model 190, e.g., model 190 is to be trained to recognize a rare event such as equipment failure, model 190 is to be trained to generate predictions of a newly seasoned or maintained chamber, etc.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features.

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). In embodiments, the training set includes synthetic microscopy images generated by synthetic data generator 174. Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

In some embodiments, one or more machine learning models 190 may be trained using historical data (e.g., historical sensor data 144, historical portions of substrate condition data 148, historical portions of gas transport parameters 152, etc.). In some embodiments, models 190 may have been trained using synthetic data 162, or a combination of historical data and synthetic data.

Predictive component 114 may provide current data to model 190 and may run model 190 on the input to obtain one or more outputs. For example, predictive component 114 may provide current portions of gas transport parameters 152 to model 190 and may run model 190 on the input to obtain one or more outputs. Current portions of gas transport parameters 152 may include parameters associated with scheduled or soon-to-be performed substrate processing procedures, operations, actions, etc. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current sensor data 146 and/or current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for processing operations/actions according to input data or component health of components of manufacturing equipment 124 and 1 indicates absolute confidence that the predictive data 168 accurately predicts properties of processing operations/actions according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current sensor data 146, current manufacturing parameters, etc.). In some embodiments, retraining may include generating one or more data sets (e.g., via data set generator 172) utilizing historical data and/or synthetic data.

For purpose of illustration, rather than limitation, aspects of the disclosure describe the training of one or more machine learning models 190 using historical data (e.g., historical sensor data 144, historical manufacturing parameters) and inputting current data (e.g., current sensor data 146, current manufacturing parameters, and current metrology data) into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical and/or synthetic data. In some embodiments, these models may be retrained utilizing a combination of true historical data and synthetic data. Predictive component 114 may monitor historical sensor data 144, historical manufacturing parameters, and metrology data 160. Any of the information described with respect to data inputs 210 of FIG. 2 may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, process control, or the like.

FIG. 2 depicts block diagram of example data set generation system 200 including data set generator 272 (e.g., data set generator 172 of FIG. 1) to create data sets for training, testing, validating, etc. a model (e.g., model 190 of FIG. 1), according to some embodiments. Data set generator 272 may be part of server machine 170 of FIG. 1. In some embodiments, several machine learning models associated with manufacturing equipment 124 may be trained, used, and maintained (e.g., within a manufacturing facility). Each machine learning model may be associated with one data set generator 272, multiple machine learning models may share a data set generator 272, etc.

FIG. 2 depicts a system 200 including data set generator 272 for creating data sets for one or more supervised models (e.g., model 190 of FIG. 1). Data set generator 272 may create data sets (e.g., data input 210, target output 220) using historical data. In some embodiments, a data set generator similar to data set generator 272 may be utilized to train an unsupervised machine learning model, e.g., target output 220 may not be generated by the data set generator.

Data set generator 272 may generate data sets to train, test, and validate a model. In some embodiments, data set generator 272 may generate data sets for a machine learning model. In some embodiments, data set generator 272 may generate data sets for training, testing, and/or validating a model configured to predict delay times associated with a time delay between initiating one or more substrate processing actions, and the actions generating a threshold level of effect at the substrate processing location. The machine learning model is provided with one or more sets of historical gas transport parameters as data input 210. The machine learning model may be provided with a first set of historical gas transport parameters 252A, a second set of historical gas transport parameters 252B, further set of historical gas transport parameters 252Z, etc. The machine learning model may be configured to accept gas transport parameters (e.g., data describing parameters of a manufacturing system) as input data and generate predictive data as output data.

Data set generator 272 may be used to generate data for any type of machine learning model that takes as input manufacturing parameter data. For example, data set generator 272 may be utilized to generate data sets for a model that makes predictions based on manufacturing equipment subsystems other than gas transport subsystems. Other types of input data may be provided as appropriate for the configuration/intended use of the model. Data set generator 272 may be used to generate data for a machine learning model that generates predicted metrology data of a substrate. Data set generator 272 may be used to generate data for a machine learning model configured to provide process control instructions. Data set generator 272 may be used to generate data for a machine learning model configured to identify a product anomaly and/or processing equipment fault.

In some embodiments, data set generator 272 generates a data set (e.g., training set, validating set, testing set) that includes one or more data inputs 210 (e.g., training input, validating input, testing input). Data inputs 210 may be provided to training engine 182, validating engine 184, or testing engine 186. The data set may be used to train, validate, or test the model (e.g., model 190 of FIG. 1).

In some embodiments, data input 210 may include one or more sets of data. As an example, system 200 may produce sets of sensor data that may include one or more of sensor data from one or more types of sensors, combinations of sensor data from one or more types of sensors, patterns from sensor data from one or more types of sensors, or the like.

In some embodiments, data input 210 may include one or more sets of data. As an example, system 200 may produce sets of historical manufacturing parameters that may include one or more of parameters associated with various subsystems, parameters for controlling one or more types of components, combination of manufacturing parameters derived from one or more types of data, patterns from manufacturing parameters, etc. Sets of data input 210 may include data describing different aspects of manufacturing, e.g., a combination of metrology data and sensor data, a combination of metrology data and manufacturing parameters, combinations of some metrology data, some manufacturing parameter data and some sensor data, etc.

In some embodiments, data set generator 272 may generate a first data input corresponding to a first set of historical gas transport parameters 252A (or another type of data input, if appropriate for the intended use of the model) to train, validate, or test a first machine learning model. Data set generator 272 may generate a second data input corresponding to a second set of historical gas transport parameters 252B to train, validate, or test a second machine learning model. Data inputs 210 may also be referred to as “features,” “attributes,” or “information.”

In some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220.

In some embodiments, data set generator 272 may generate data for training a machine learning model configured to output predictive data indicative of a time delay between initiating a substrate processing action and an effect on conditions proximate the substrate satisfying a threshold condition. In some embodiments, data set generator 272 may provide the data set to training engine 182, validating engine 184, or testing engine 186, where the data set is used to train, validate, or test the machine learning model (e.g., one of the machine learning models that are included in model 190, ensemble model 190, etc.). Data set generator 272 may generate target output 220 to be provided for generating a trained machine learning model (e.g., for training, validating, testing, etc.). Target output 220 may be related to the intended output of the model. Target output 220 may include action delay time 268 related to measured delay times of effects on conditions proximate a substrate compared to initiation times of actions that cause the effects. The model may be trained to predict delay times based on the input combination of manufacturing parameters (e.g., gas transport parameters) provided to the model.

In some embodiments, data inputs 210 may include information for a specific type of manufacturing equipment, e.g., manufacturing equipment sharing specific characteristics. Data inputs 210 may include data associated with a device of a certain type, e.g., intended function, design, produced with a particular recipe, etc. Training a machine learning model based on a type of equipment, device, recipe, etc. may allow the trained model to generate plausible predictive data in a number of settings (e.g., for a number of different facilities, products, etc.).

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., predictive data 168 of FIG. 1), according to some embodiments. In some embodiments, system 300 may be used in conjunction with a machine learning model configured to generate data for adjusting a process recipe (e.g., model 190 of FIG. 1). In some embodiments, system 300 may be used in conjunction with a machine learning model to determine a corrective action associated with manufacturing equipment. A corrective action may include updating a process recipe, adjusting a process procedure in progress, etc. In some embodiments, system 300 may be used in conjunction with a machine learning model to determine a fault of manufacturing equipment. In some embodiments, system 300 may be used in conjunction with a machine learning model to cluster or classify substrates. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training data includes action delay data 364. Action delay data 364 may include manufacturing parameters, time delay data related to effects experienced by the substrate based on the manufacturing parameters, etc. Training data may include historical data, such as historical metrology data, historical sensor data, historical classification data (e.g., classification of whether a product meets performance thresholds), historical microscopy image data, etc. Action delay data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training data 364 includes sensor data, including features derived from sensor data from 20 sensors (e.g., sensors 126 of FIGS. 1) and 10 manufacturing parameters (e.g., manufacturing parameters that correspond to the same processing runs(s) as the sensor data from the 20 sensors), the sensor data may be divided into a first set of features including sensors 1-10 and a second set of features including sensors 11-20. The manufacturing parameters may also be divided into sets, for instance a first set of manufacturing parameters including parameters 1-5, and a second set of manufacturing parameters including parameters 6-10. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., a set of gas delivery parameters, etc.) to generate an output. The output may include a predicted delay between initiation of actions and a desired effect (e.g., a property value at the location of the substrate meeting a target threshold) at the location of a substrate. The output may be compared to a label of the training data item (e.g., actual measurements of delay corresponding to the input process conditions and target property value).

Processing logic may then compare the generated output (e.g., predicted delay) to the label (e.g., measured delay) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., sensor data from sensors 1-10, manufacturing parameters 1-10, etc.) and to generate a second trained model using the second set of features in the training set (e.g., sensor data from sensors 11-20, manufacturing parameters 11-20, etc.). In some embodiments, the first trained model and the second trained model may be combined to generate a third trained model (e.g., which may be a better predictor or synthetic data generator than the first or the second trained model on its own). In some embodiments, sets of features used in comparing models may overlap (e.g., first set of features being sensor data from sensors 1-15 and second set of features being sensors 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., sensor data from sensors 1-10 or manufacturing parameters 1-10) and the second trained model using the second set of features in the validation set (e.g., sensor data from sensors 11-20 or manufacturing parameters 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., sensor data from sensors 1-10), the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current data 322 and determines (e.g., extracts), from the output of the trained model, predictive data 324. Current data 322 may be manufacturing parameters related to a process, operation, or action of interest. Current data 322 may be manufacturing parameters related to a process under development, redevelopment, investigation, etc. Current data 322 may be manufacturing parameters related to a gas transport system. Current data 322 may be manufacturing parameters that may have an effect on delay of changes to condition values compared to initiation of condition-altering actions. Current data 322 may be manufacturing parameters related to gas delivery and/or gas removal in association with a substrate processing chamber. A corrective action associated with the manufacturing equipment 124 of FIG. 1 may be performed in view of predictive data 324. In some embodiments, current data 322 may correspond to the same types of features in the historical data used to train the machine learning model. In some embodiments, current data 322 corresponds to a subset of the types of features in historical data that are used to train selected model 308. For example, a machine learning model may be trained using a number of manufacturing parameters, and configured to generate output based on a subset of the manufacturing parameters.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc.

Generation of a new model may include providing additional training data 346. Generation of a new model may further include providing current data 322, e.g., data that has been used by the model to make predictions. In some embodiments, current data 322 when provided for generation of a new model may be labeled with an indication of an accuracy of predictions generated by the model based on current data 322. Additional training data 346 may be provided to model training of block 312 for generation of one or more new machine learning models, updating, retraining, and/or refining of selected model 308, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-D are flow diagrams of methods 400A-D associated with training and utilizing models, according to certain embodiments. The models may by physics based models, machine learning models, heuristic or rule-based models, etc. The models may be used in association with precision timing of substrate processing actions. Methods 400A-D may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-D may be performed, in part, by predictive system 110. Method 400A may be performed, in part, by predictive system 110 (e.g., server machine 170 and data set generator 172 of FIG. 1, data set generator 272 of FIG. 2). Predictive system 110 may use method 400A to generate a data set to at least one of train, validate, or test a machine learning model, in accordance with embodiments of the disclosure. Methods 400B-D may be performed by predictive server 112 (e.g., predictive component 114) and/or server machine 180 (e.g., training, validating, and testing operations may be performed by server machine 180). Methods 400B-D may be performed by corrective action component 122. In some embodiments, a non-transitory machine-readable storage medium stores instructions that when executed by a processing device (e.g., of predictive system 110, of server machine 180, of predictive server 112, etc.) cause the processing device to perform one or more of methods 400A-D.

For simplicity of explanation, methods 400A-D are depicted and described as a series of operations. However, operations in accordance with this disclosure can occur in various orders and/or concurrently and with other operations not presented and described herein. Furthermore, not all illustrated operations may be performed to implement methods 400A-D in accordance with the disclosed subject matter. In addition, those skilled in the art will understand and appreciate that methods 400A-D could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of sensor, manufacturing parameters, metrology data, etc. In some embodiments, the first data input may include a first set of features for types of data and a second data input may include a second set of features for types of data (e.g., as described with respect to FIG. 3). Input data may include historical data and/or synthetic data in some embodiments.

In some embodiments, at block 403, processing logic optionally generates a first target output for one or more of the data inputs (e.g., first data input). In some embodiments, the input includes one or more manufacturing parameters and the output includes predicted action delay. In some embodiments, the input includes gas transport parameters and the output includes a recommended update to a recipe to account for a delay between initiation of gas delivery actions and arrival of a threshold level of gas at the location of the substrate. In some embodiments, the first target output is predictive data.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing corrective actions associated with manufacturing equipment 124.

FIG. 4B is a flow diagram of a method 400B for performing a corrective action based on a substrate processing delay time, according to some embodiments. At block 410, processing logic identifies a target substrate process operation start time. The start time corresponds to a time of initiation of one or more substrate process actions. A substrate process operation start time may refer to a nominal start time of a substrate process operation or a step of a substrate process procedure. A substrate process operation start time may refer to a recipe start time of some substrate processing action, such as a deposition or etch action. A substrate process operation start time may refer to an intended start condition, e.g., a process gas is to be supplied when temperature of a substrate reaches a target value. A substrate process operation start time may refer to an intended start time, e.g., a target time for a substrate to reach a target temperature, be provided with a target concentration of a process gas, or the like. In some embodiments, instead or in addition to the substrate operation start time, a target substrate process operation end time may be identified. The substrate operation end time may share one or more features with a substrate operation start time, for example may be associated with a time where a concentration of process gas proximate the substrate is to be below a target threshold, etc. The substrate process operation end time may be associated with a target time for concentration of a process gas to satisfy a target threshold condition, e.g., for concentration to be below some target value. In some embodiments, a second process operation time (e.g., second start time, second end time) may also be identified. The second process operation time may occur at the same time as the first process operation start time. For example, two process conditions may be intended to occur at the location of the substrate synchronously or simultaneously. A first process gas and a second process gas may be intended to be delivered to the substrate at a target operation start time. The second process operation time may occur at a different time than the first process operation start time.

In some embodiments, the substrate process operation associated with the substrate process operation start time may be part of a substrate process procedure (e.g., substrate processing according to a substrate processing recipe). The substrate process procedure may include many instances of utilizing one or more subsystems. For example, the substrate process procedure may include many process gas introduction and evacuation/flushing operations, many temperature change operations, many plasma operations, many etch operations, many deposition operations, or the like. Throughput may be improved based on a number of operations included in the substrate processing procedure. In some embodiments, the substrate process procedure may repeat one or more operations many times, e.g., the substrate process procedure may be a cyclic procedure, may include a set of cyclically repeated process operations, etc. The cyclically repeated process operations may include delivery of the first process gas to the process chamber, removal of the gas, reintroduction of the same process gas or another process gas, etc.

At block 412, processing logic provides one or more parameters of a gas transfer system to a model. The gas transfer system is associated with the substrate process operation. In some embodiments, a different subsystem and/or one or more additional subsystems may be including instead of or in addition to a gas transfer system. For example, parameters of a different or additional subsystem may be provided to the model. Parameters of a plasma generation system, temperature selection system, or another system related to substrate processing may be provided to the model. Parameters may include any hardware, software, equipment constants, or other contributing factor to performing the target substrate processing action or operation. The model may be a physics-based model. The physics-based model may have been refined, calibrated, trained, or the like with experimental data, e.g., following a procedure such as that described in connection with FIG. 3. The model may be a heuristic or rule-based model. The model may be a trained machine learning model.

Parameters of the system may include any parameters that will or are suspected to have an effect on a delay between initiation of one or more actions and an effect occurring at the location of the substrate. Parameters of a gas transfer system may include a source location of a process gas. For example, a gas transfer system may include multiple inlets, multiple ports, multiple reservoirs, multiple gas sources, etc. A location may have an effect on a flow path, a delay time, etc. Parameters of a gas transfer system may include a source location of further process gases, carrier gases, etc. Parameters of a gas transfer system may include locations of connections in a gas transfer system. For example, a process gas may encounter, between a source location and the process chamber, an inlet for a carrier gas, which may increase a delay time of providing the process gas. Parameters of a gas transfer system may include one or more delivery zones and/or a ratio of gas delivery to various zones of the process chamber. For example, a process chamber may include multiple gas delivery zones, corresponding to different spatial regions of a substrate or of the process chamber. A target delivery zone or a distribution of delivery to multiple zones may be included as a parameter of the system. Parameters of a gas transfer system may include gas identity, including one or more carrier gases, one or more process gases, etc. Parameters of a gas transfer system may include a gas mix, such as a proportion of a gas mix that is a first material, a proportion that is a second material, etc. Parameters of a gas transfer system may include a pressure of one or more gases, such as a source pressure, a reservoir pressure, etc. Parameters of a gas transfer system may include specifications of components, such as a maximum or target pumping speed of an evacuation system.

At block 414, processing logic obtains first output from the model. The output includes an indication of a first preemptive time period for initiation of gas delivery actions (e.g., opening of one or more valves). Initiating gas delivery actions in accordance with the first preemptive time period corresponds to delivery of a first process gas to a process chamber within a threshold time window of the substrate process operation start time. The preemptive time period may be associated with a delay between initiating some substrate processing action or actions, and conditions at the location of the substrate reaching some target value in response to the substrate processing action or actions. In some embodiments, a second, third, etc., preemptive time period may be provided. Additional preemptive time periods may be provided that are associated with different substrate processing actions, different threshold condition values, different levels of certainty of achieving a target condition value at the target time, etc. A preemptive time period may be associated with the end of a substrate processing operation, e.g., a time delay between beginning removal of a process gas and concentration of the process gas reaching a threshold value.

In some embodiments, various aspects of operations of block 414 may be adjusted. The preemptive time period may be associated with a different target subsystem than a gas transfer system. The initiation actions may be associated with gas removal (e.g., at an operation end time) instead of or in addition to gas delivery. The initiation actions may be associated with a different subsystem, such as initiating introduction of plasma or RF power, initiating a substrate temperature change, etc. Initiating substrate processing actions in accordance with the first preemptive time period may cause condition values at the location of the substrate to satisfy one or more threshold conditions at the start time of the substrate process operation. Initiating substrate processing actions in accordance with the preemptive time period may cause condition values at the location of the substrate to satisfy one or more threshold conditions at a target time (e.g., the substrate process operation start time). Initiating substrate processing actions in accordance with the preemptive time period may cause gas concentration at the substrate to satisfy one or more threshold conditions at a target time. Initiating substrate processing actions in accordance with the preemptive time period may cause conditions proximate the substrate to reach within a threshold window of a target value at a target time. Initiating substrate processing actions in accordance with the preemptive time period may cause conditions proximate the substrate to reach within a threshold condition value window of target values at a time within a threshold time window of a target time.

At block 416, processing logic causes performance of a corrective action based on the output from the model. The corrective action may include altering or adjusting a substrate processing operation in accordance with the preemptive time period. The corrective action may include causing a manufacturing system to initiate one or more substrate processing actions earlier to account for a delay between initiation of substrate processing actions and changing of conditions at the location of the substrate. The corrective action may include updating a process recipe associated with the substrate process operation. The corrective action may include updating one or more process recipes that include the substrate process operation. The corrective action may include updating an equipment constant of a manufacturing system. The corrective action may include updating an equipment constant associated with the process chamber in view of the first preemptive time period. The corrective action may include adjusting future operations of a substrate processing procedure in progress.

FIG. 4C is a flow diagram of a method 400C for generating a trained machine learning model for predictive time delay data associated with substrate processing, according to some embodiments. At block 420, processing logic obtains a first plurality of gas transfer parameter data. The plurality of gas transfer parameter data may share one or more features with parameter data described in connection with FIG. 4B. In some embodiments, the parameter data may be related to a different subsystem than a gas transfer subsystem, such as an RF system, plasma generation system, temperature selection system, etc. In some embodiments, the parameter data may be related to multiple subsystems. In some embodiments, the model may be configured to generate time delay data and/or preemptive time duration data for one or more condition values, one or more substrate processing subsystems, one or more process operation start and/or end times, etc. Gas transfer parameter data may include one or more target delivery zones in the process chamber for one or more gases. Gas transfer parameter data may include one or more source locations of process gas and/or carrier gas. Gas transfer parameter data may include one or more gas identities, including carrier gas identity, process gas identity, etc. Gas transfer parameter data may include a pressure of a gas, including a reservoir pressure, source pressure, or the like.

At block 422, processing logic obtains a first plurality of time delay data. The plurality of time delay data corresponds to the first plurality of gas transfer parameter data. In some embodiments, the time delay data may relate to parameters other than gas transfer parameters, e.g., if the machine learning model is to target a different subsystem than a gas transfer subsystem. Each of the first plurality of time delay data corresponds to a duration of time between performance of one or more gas transfer operations and accumulation of a threshold concentration of one or more process gases in a substrate processing chamber. In some embodiments, each of the first plurality of time delay data may correspond to a duration of time between performance and/or initiation of other substrate processing operations (e.g., other than gas transfer operations) and a change to conditions at the location of the substrate satisfying a threshold condition. The plurality of time delay data may be generated by measuring conditions or proxies of conditions proximate a substrate after initiating one or more substrate processing actions. For example, time delay data may be generated by receiving sensor data sensitive to a concentration of a process gas near a substrate processing location. Sensor data may be data from a sensor sensitive to electromagnetic radiation associated with a target gas. Sensor data may be data from a sensor configured to receive emitted light from a process gas. Sensor data may be data from an optical gas emission sensor.

At block 424, processing logic provides the first plurality of gas transfer parameter data to the machine learning model as training input. In some embodiments, different or additional parameters may be provided to the machine learning model as training input, for example in accordance with types of parameters discussed in connection with block 420 or FIG. 4B.

At block 426, processing logic provides the first plurality of time delay data to the machine learning model as target output. In some embodiments, the time delay data may relate to various processing parameters.

At block 428, processing logic trains the machine learning model to generate a trained machine learning model. The trained machine learning model is configured to receive as input gas transfer parameters and generate as output time delay data. In some embodiments, the trained machine learning model may accept, instead or additionally, other manufacturing parameters as input, as discussed in connection with FIG. 4B. The output time delay data may be indicative of a preemptive time period to be incorporated into a substrate processing operation.

In some embodiments, the method may further include use of the trained machine learning model. For example, manufacturing parameters of interest may be provided to the trained model, and a prediction of a delay between initiation of one or more substrate processing actions and a target effect at a substrate processing location may be provided as output. In some embodiments, the trained machine learning model may be provided with gas transfer parameter data. The gas transfer parameter data may be related to providing a gas to a substrate. The gas transfer parameter data may be related to removing a gas from a substrate, e.g., providing a flushing gas to replace a process gas. Processing logic may obtain from the model time delay data, and a corrective action may be performed in view of the time delay. A corrective action may include updating a process recipe to update a time of initiation of one or more substrate processing actions or operations. A corrective action may include updating one or more equipment constants to adjust a time of initiation. A corrective action may include updating a process recipe and/or equipment constant to update a time of initiation of one or more gas transfer operations in view of the first time delay.

FIG. 4D is a flow diagram of a method 400D for causing delivery of process gas to a process chamber within a target time window, according to some embodiments. At block 430, processing logic identifies a target substrate process operation start time, e.g., from a substrate processing recipe. The start time corresponds to a time of initiation of one or more substrate process actions, such as a target time of initiation of an etch process, deposition process, or the like. Operations of block 430 may share one or more features with operations of block 410 of FIG. 4B.

At block 432, processing logic provides to a model first one or more parameters of a gas transfer system associated with the substrate process operation. The parameters may be associated with providing a gas to a process chamber and/or removing a gas from a process chamber. Further parameters may be provided related to additional gases, additional operations, etc. Operations of block 432 may share one or more features with operations of block 412 of FIG. 4B.

At block 434, processing logic obtains first output from the model. The first output includes an indication of a first preemptive time period for initiation of first one or more gas delivery actions. The preemptive time period may correspond to a change in conditions in the process chamber associated with gas transfer occurring at the nominal substrate process operation start time. Processing logic may further receive additional output from the model, e.g., associated with second gas delivery actions, associated with gas removal actions, etc.

At block 436, processing logic performs an action in accordance with the first preemptive time period to cause delivery of a first process gas to a process chamber. The first process gas is delivered to the process chamber within a threshold time window of the substrate process operation start time. The action may be setting a time of initiation of one or more gas transfer actions, such as actuating valves, adjusting operation of pumps, or the like. The action may be setting a time of initiation for a future operation, e.g., in recipe design. The action may be adjusting a planned time of initiation of a future operation, e.g., in updating a process recipe.

The action may be adjusting a planned time of initiation of a future gas transfer action based on a current gas transfer action. For example, the substrate process operation may be included in a substrate process procedure. Upon determining that a gas transfer does not correspond to a target condition at a target time, future operations of the same substrate process procedure may be adjusted to enable target gas conditions to be achieved at subsequent target times, e.g., for subsequent process operations.

In some embodiments, determining a preemptive time period may inform further actions. For example, if a preemptive time period changes, it may indicate that a process tool is aging, drifting, failing, or the like. If a preemptive time period changes, it may indicate that one or more components of the process tool are aging, drifting, failing, or the like. Determining, based on the preemptive time period, that one or more components are failing, drifting, aging, or the like, may enable scheduling of maintenance, scheduling of cleaning or seasoning, scheduling of component replacement, or the like.

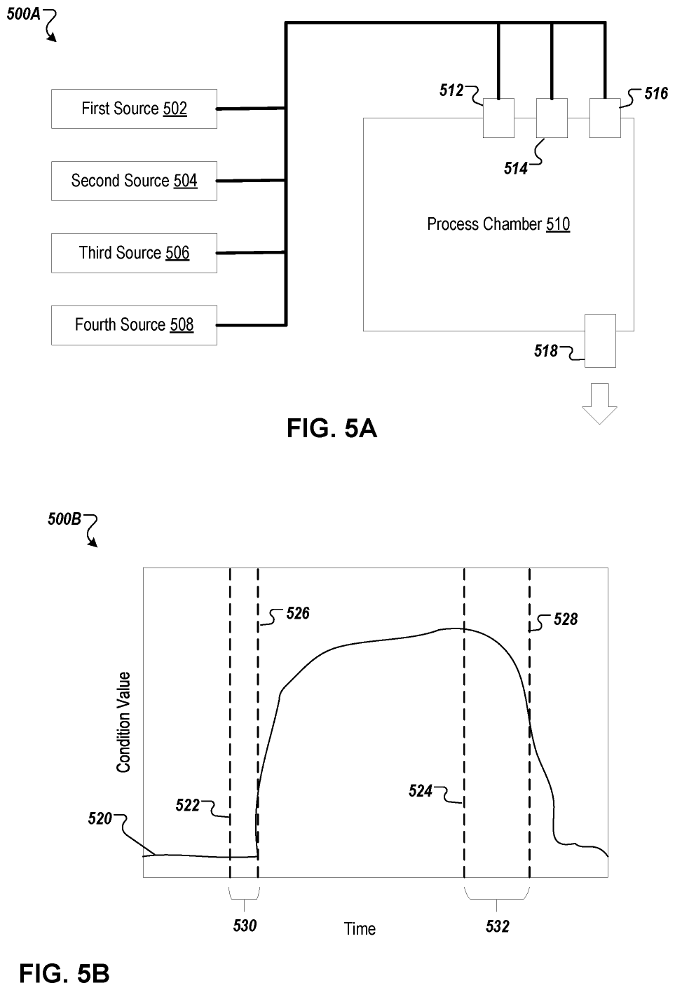

FIG. 5A is a block diagram of a gas transfer system 500A, according to some embodiments. Gas transfer system 500A includes a number of sources for gas delivery, e.g., sources 502-508. Each source may be a gas reservoir, a port for introduction to the gas delivery system, or the like. A gas transfer system may include many gas sources. Each source may be for providing a different gas. Multiple sources may provide the same gas. Different sources may be associated with different gas mixes, gas identities, gas pressures, or the like.

Gas transfer system 500A may cause gas to be delivered to process chamber 510. Delivery to process chamber 510 may occur in a number of different delivery locations, areas, zones, or the like. For example, a number of inlets 512-516 may be included in the gas transfer system for delivery of gas to different areas of the process chamber 510. Pictured is a gas inlet for a central delivery zone 512, a gas inlet for an outer delivery zone 516, and a gas inlet for an intermediate delivery zone 514. A gas inlet may correspond to multiple outlets for delivery into process chamber 510. For example, the gas inlet for outer delivery zone 516 may include gas delivery around the edges of process chamber 510, proximate edges of a substrate processing region of process chamber 510, proximate edges of a substrate support of process chamber 510, etc.

Gas transfer system 500A further includes exhaust port 518, which is fluidly coupled to a pumping system. The pumping system may be utilized in evacuating process chamber 510, flushing process chamber 510, etc.

Parameters related to gas transfer system 500A may be provided to a model to obtain predictions of a delay related to gas delivery. Gas delivery may include actuation of a valve, such as a valve separating gas of first source 502 from the remainder of the gas transfer system 500A. A source location of a gas may be provided as a parameter. A source location of multiple gases, including process gas, carrier gas, etc., may be provided as parameters. An arrangement of gas sources may be included in data that causes output from the model. For example, a gas provided from a source further from a process chamber (e.g., fourth source 508) may have an increased delay if another gas is provided to the same delivery system between the further source and the chamber (e.g., if a gas is also provided at second source 504).

FIG. 5B is a time trace plot 500B of condition values in a process chamber, according to some embodiments. Plot 500B includes time trace 520. Time trace 520 shows a measured value associated with substrate processing over time. The dependent variable of plot 500B may be any property of interest, or a proxy or related value for the property of interest. For example, time trace 520 may be associated with a gas transfer system. The condition of interest may be a concentration of a target gas at or near the location of the substrate. The dependent variable of time trace 520 may be concentration, an estimate of concentration based on a different measured property, the measured property as a proxy of concentration, etc. For example, the dependent variable of time trace 520 may be optical emission data from a target gas.

Plot 500B includes nominal operation start time 522 and nominal operation end time 524. Nominal operation start time 522 may be a start time according to a recipe. Nominal operation end time 524 may be an end time according to a process recipe.

Plot 500B also includes measured operation start time 526 and measured operation end time 528. A measured operation start and/or end time may depend upon a measured property value. For example, measured operation start time 526 may be when a concentration of a process gas at a location proximate the substrate reaches a threshold value, and measured operation end time 528 may be when a concentration of the process gas is reduced to a second threshold value.

First time delay 530 and second time delay 532 may reflect a disconnect between nominal timings associated with one or more substrate processing actions and timings of condition changes as occur at the substrate processing location. First time delay 530 may be related to a first preemptive time duration. The first preemptive time duration may be utilized in adjusting substrate processing action initiation times to more finely control a timing of condition changes at the location of the substrate. Second time delay 532 may be related to a second preemptive time duration. The second preemptive time duration may be utilized in adjusting substrate processing action initiation times to more finely control a second timing of second condition changes at the location of the substrate. First time delay 530, second time delay 532, and parameters related to the time delays may be provided to a model for training. A trained model may provide predictions of one or more of first time delay 530 and second time delay 532 based on manufacturing parameters provided to the trained model.

In some embodiments, a certain delay between a nominal operation start time and a threshold gas concentration may be targeted. For example, a delay of 100 ms or less may be targeted between the operation start time and reaching the threshold gas concentration. For some procedures, such limits may be approached iteratively. For example, various gas introduction operations may be performed, gas concentrations measured, and the gas introduction operations may be updated based on the measurements to more closely align with the target delay time. Delay values may then be locked (e.g., for a certain set of manufacturing equipment, for a certain processing procedure or operation, or the like) or delay values may continue to be iteratively updated, e.g., to account for drift of various components of the manufacturing equipment.

Delay values (e.g., first time delay 530, second time delay 532) may be inferred by collecting gas data, in some embodiments. One or more processing operations may be performed with initial gas providing function delay values. The initial delay values may coincide with the nominal operation start times, or may be initial guesses of gas providing function delay values. Sensor data may be collected during the one or more processing operations. For example, gas emission measurements may be collected from a processing chamber to determine timing of in-chamber concentrations of one or more process gases.

Delay values may be inferred from measurements taken from the one or more processing operations including the initial gas providing function delay timings. Fitting operations may be performed to determine optimal delay values (e.g., delay values resulting in gas delivery occurring within a threshold time delay of a target delivery time) from multiple gas sources. The delay values may be used to update one or more processing recipes, update performance of future one or more processing operations, etc. Such a method may also be performed iteratively, e.g., the updated delay values may be used as initial delay values, and further changes may be made based on sensor data collected during a processing operation utilizing the updated delay values.

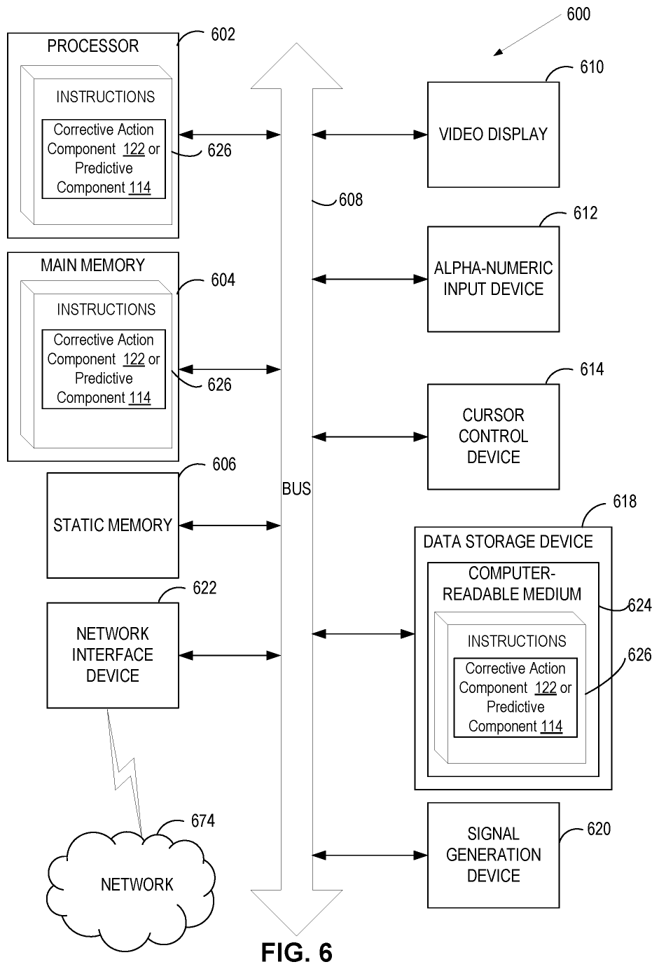

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., predictive component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
identifying a target substrate process operation start time, wherein the start time corresponds to a time of initiation of one or more substrate process actions;
providing to a model first one or more parameters of a gas transfer system associated with the substrate process operation;
obtaining first output from the model, wherein the first output comprises an indication of a first preemptive time period for initiation of first one or more gas delivery actions; and
updating a process recipe, in accordance with the first preemptive time period, to cause the first one or more gas delivery actions to deliver a first process gas to a process chamber within a threshold time window of the substrate process operation start time.

2. The method of claim 1, further comprising:
providing, to the model, second one or more parameters of the gas transfer system;
obtaining second output from the model, wherein the second output comprises an indication of a second preemptive time period for initiation of second one or more gas delivery actions; and
updating the process recipe, in accordance with the second preemptive time period, to cause the second one or more gas delivery actions to deliver a second process gas to the process chamber within the threshold time window of the substrate process operation start time.

3. The method of claim 1, further comprising:
identifying a target substrate process operation end time;
providing, to the model, third one or more parameters of the gas transfer system associated with the substrate process operation;
obtaining third output from the model, wherein the third output comprises an indication of a third preemptive time period for initiation of one or more gas removal actions; and
updating the process recipe, in accordance with the third preemptive time period, to cause the one or more gas removal actions to cause a concentration of a third process gas in the process chamber to satisfy a target threshold condition at the target substrate process operation end time.

4. The method of claim 1, wherein the model comprises at least one of:
a physics-based model;
a heuristic model; or
a trained machine learning model.

5. The method of claim 1, wherein a substrate process procedure comprises the substrate process operation, and wherein the substrate process procedure further comprises a plurality of operations to deliver the first process gas to the process chamber.

6. The method of claim 5, wherein the substrate process procedure comprises a set of cyclically repeated process operations to deliver the first process gas to the process chamber.

7. The method of claim 1, wherein the first one or more parameters of the gas transfer system comprise one or more of:
one or more target delivery zones in the process chamber;
a source location of the first process gas;
a carrier gas identity;
a process gas identity;
a source location of the carrier gas; or
a pressure of the carrier gas or the process gas.

8. The method of claim 1, further comprising performing a corrective action in view of the first preemptive time period.

9. A method, comprising:
obtaining a first plurality of gas transfer parameter data;
obtaining a first plurality of time delay data, wherein the first plurality of time delay data corresponds to the first plurality of gas transfer parameter data, and wherein each of the first plurality of time delay data corresponds to a duration of time between performance of one or more gas transfer operations and accumulation of a threshold concentration of one or more process gases in a substrate processing chamber;
providing the first plurality of gas transfer parameter data to a machine learning model as training input;
providing the first plurality of time delay data to the machine learning model as target output; and
training the machine learning model to generate a trained machine learning model, wherein the trained machine learning model is configured to receive as input gas transfer parameters and generate as output time delay data.

10. The method of claim 9, further comprising:
providing to the trained machine learning model first gas transfer parameter data;
obtaining from the trained machine learning model a first time delay; and
performing a corrective action in view of the first time delay.

11. The method of claim 10, wherein the corrective action comprises updating a process recipe to update a time of initiation of one or more gas transfer operations in view of the first time delay.

12. The method of claim 9, wherein the gas transfer parameter data comprises one or more of:
target delivery zones in the process chamber;
a source location of a process gas;
a carrier gas identity;
a process gas identity;
a source location of the carrier gas; or
a pressure of the carrier gas or the process gas.

13. The method of claim 9, wherein the time delay data is generated by receiving sensor data associated with a sensor detecting presence of a target gas in the substrate processing chamber, wherein the sensor is an electromagnetic sensor detecting radiation from the target gas.

14. A non-transitory machine-readable storage medium storing instructions which, when executed, cause a processing device to perform operations comprising:
identifying a target substrate process operation start time, wherein the start time corresponds to a time of initiation of one or more substrate process actions;
providing to a model first one or more parameters of a gas transfer system associated with the substrate process operation;
obtaining first output from the model, wherein the first output comprises an indication of a first preemptive time period for initiation of first one or more gas delivery actions; and
initiating the first one or more gas delivery actions, in accordance with the first preemptive time period, to deliver a first process gas to a process chamber within a threshold time window of the substrate process operation start time.

15. The non-transitory machine-readable storage medium of claim 14, the operations further comprising:
providing, to the model, second one or more parameters of the gas transfer system; and
obtaining second output from the model, wherein the second output comprises an indication of a second preemptive time period for initiation of second one or more gas delivery actions; and
initiating second one or more gas delivery actions, in accordance with the second preemptive time period, to deliver a second process gas to the process chamber within the threshold time window of the substrate process operation start time.

16. The non-transitory machine-readable storage medium of claim 14, the operations further comprising:
identifying a target substrate process operation end time;
providing, to the model, third one or more parameters of the gas transfer system associated with the substrate process operation;
obtaining third output from the model, wherein the third output comprises an indication of a third preemptive time period for initiation of one or more gas removal actions; and
initiating the one or more gas removal actions, in accordance with the third preemptive time period, to cause a concentration of a third process gas in the process chamber to satisfy a target threshold condition at the target substrate process operation end time.

17. The non-transitory machine-readable storage medium of claim 14, wherein the model comprises:
a physics-based model;
a heuristic model; or
a trained machine learning model.

18. The non-transitory machine-readable storage medium of claim 14, wherein a substrate process procedure comprises the substrate process operation, and wherein the substrate process procedure further comprises a plurality of operations comprising delivery of the first process gas to the process chamber.

19. The non-transitory machine-readable storage medium of claim 18, wherein the substrate process procedure comprises a set of cyclically repeated process operations comprising delivery of the first process gas to the process chamber.

20. The non-transitory machine-readable storage medium of claim 14, wherein the first one or more parameters of the gas transfer system comprise one or more of:
one or more target delivery zones in the process chamber;
a source location of the first process gas;
a carrier gas identity;
a process gas identity;
a source location of the carrier gas; or
a pressure of the carrier gas or the process gas.
